(19) United States
(12) Patent Application Publication
(10) Pub. No.: US 2026/0075647 A1
(43) Pub. Date: Mar. 12, 2026

(54) METHODS, ARCHITECTURES, APPARATUSES AND SYSTEMS DIRECTED TO CHANNEL ACCESS WITH CHANNEL OCCUPANCY TIME SHARING FOR SIDELINK (SL) MODE-1 WITH Uu-UNLICENSED and SL-UNLICENSED

(71) Applicant: InterDigital Patent Holdings, Inc., Wilmington, DE (US)

(72) Inventors: Yifan Li, Conshohocken, PA (US); Pascal Adjakple, Great Neck, NY (US); Umer Salim, Vallauris (FR); Virgile Garcia, Antibes (FR); Guodong Zhang, Woodbury, NY (US); Kyle Pan, Saint James, NY (US); Ravikumar Pragada, Warrington, PA (US)

(21) Appl. No.: 19/130,424

(22) PCT Filed: Nov. 15, 2023
(86) PCT No.: PCT/US2023/079754

§ 371 Date: May 15, 2025

Related U.S. Application Data
(60) Provisional application No. 63/425,899, filed on Nov. 16, 2022.

(51) Int. Cl. H04W 74/0808; H04W 92/18

(52) U.S. Cl. CPC H04W 74/0808; H04W 92/18

(57) ABSTRACT

Procedures, methods, architectures, apparatuses, systems, devices, and computer program products directed to channel access with channel occupancy time (COT) sharing are described herein. A method implemented in a wireless transmit/receive unit (WTRU) includes transmitting, to a base station, first scheduling information associated with a SL transmission to be transmitted to another WTRU in unlicensed spectrum. The method includes receiving, from the base station, second scheduling information indicating a scheduling of the SL transmission and a shared COT, wherein the shared COT may be shared between any of uplink, downlink and sidelink transmissions. The method includes determining that the SL transmission is scheduled in the shared COT. The method includes transmitting the SL transmission to the other WTRU with no listen before talk (LBT) or with a shorter LBT than a full LBT based on the determining that the SL transmission may be scheduled in the shared channel occupancy time.

### CROSS-REFERENCE TO RELATED APPLICATIONS

This application claims the benefit of U.S. Patent Application No. 63/425,899 filed Nov. 16, 2022, which is incorporated herein by reference in its entirety.

### TECHNICAL FIELD

The present disclosure is generally directed to the fields of communications, software and encoding, including, for example, to methods, architectures, apparatuses, systems directed to channel access with channel occupancy time (COT) sharing for sidelink (SL) mode-1 with Uu-unlicensed (e.g., uplink/downlink unlicensed) and SL-unlicensed.

### BACKGROUND

Sidelink (SL) relaying was introduced in third generation partnership project (3GPP) release 17 to extend the network coverage. Any of SL and Uu (e.g., uplink/downlink) may use an unlicensed band. Before transmitting in an unlicensed band, a wireless transmit/receive unit (WTRU) may perform channel sensing for determining availability of the channel. Embodiments described herein have been designed with the foregoing in mind.

### SUMMARY

Methods, architectures, apparatuses, and systems directed to channel access with COT sharing for SL mode-1 with Uu-unlicensed and SL-unlicensed are described herein. In the following, there are defined and described methods and apparatuses for improving channel access with COT sharing for SL mode-1 with Uu-unlicensed and SL-unlicensed, and that are claimed according to the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of 5G network characteristics versus LTE network characteristics;

FIG. 3 is a diagram illustrating an example of SL mode 1 operation using dynamic scheduling;

FIG. 4 is a diagram illustrating an example channel access procedure with COT sharing initiated by a Tx WTRU;

FIG. 5 is a diagram illustrating an example channel access procedure with COT sharing initiated by a Tx WTRU with assistance information from the Rx WTRU;

FIG. 6 is a diagram illustrating an example channel access procedure with COT sharing initiated by the gNB;

FIG. 7 is a diagram illustrating an example channel access procedure with COT sharing initiated by the gNB with assistance information from the Rx WTRU;

FIG. 8 is a diagram illustrating an example channel access method with WTRU initiated COT sharing;

FIG. 9 is a diagram illustrating an example channel access method with gNB initiated COT sharing;

FIG. 10 is a diagram illustrating an example method for sharing a COT between a WTRU and a base station;

FIG. 11 is a diagram illustrating an example method for sharing a COT between a WTRU and a base station, the shared COT being initiated by the base station; and

FIG. 12 is a diagram illustrating an example method for sharing a COT between a WTRU and a base station, the shared COT being initiated by the WTRU.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

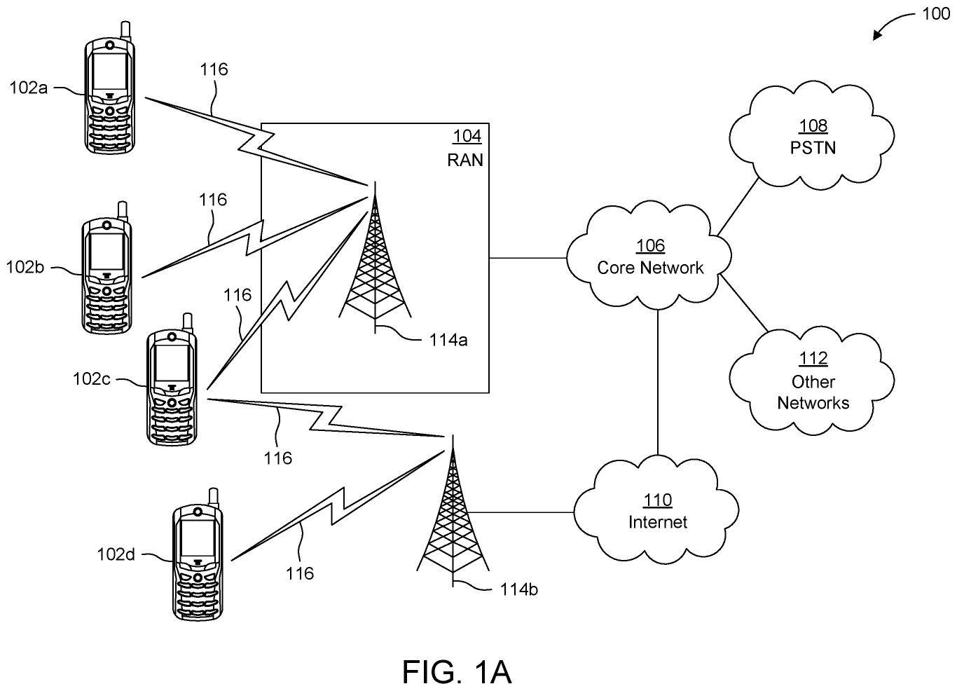

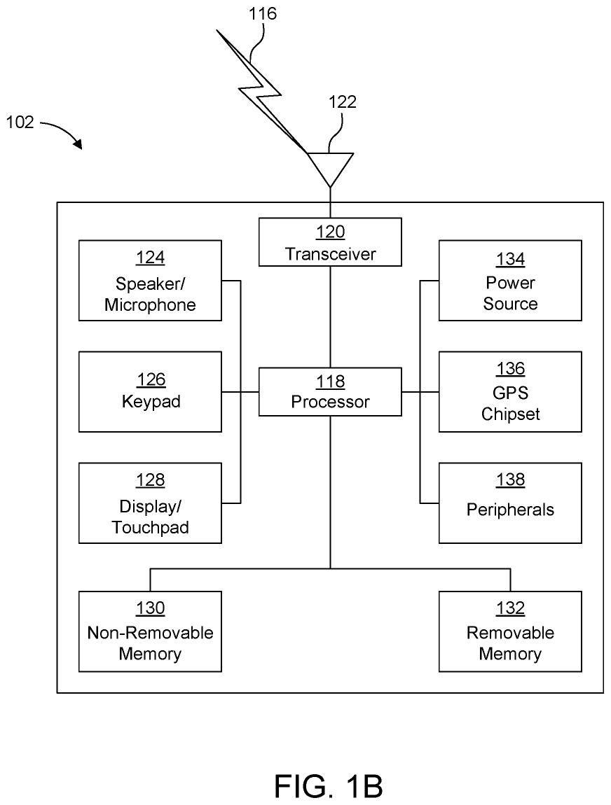

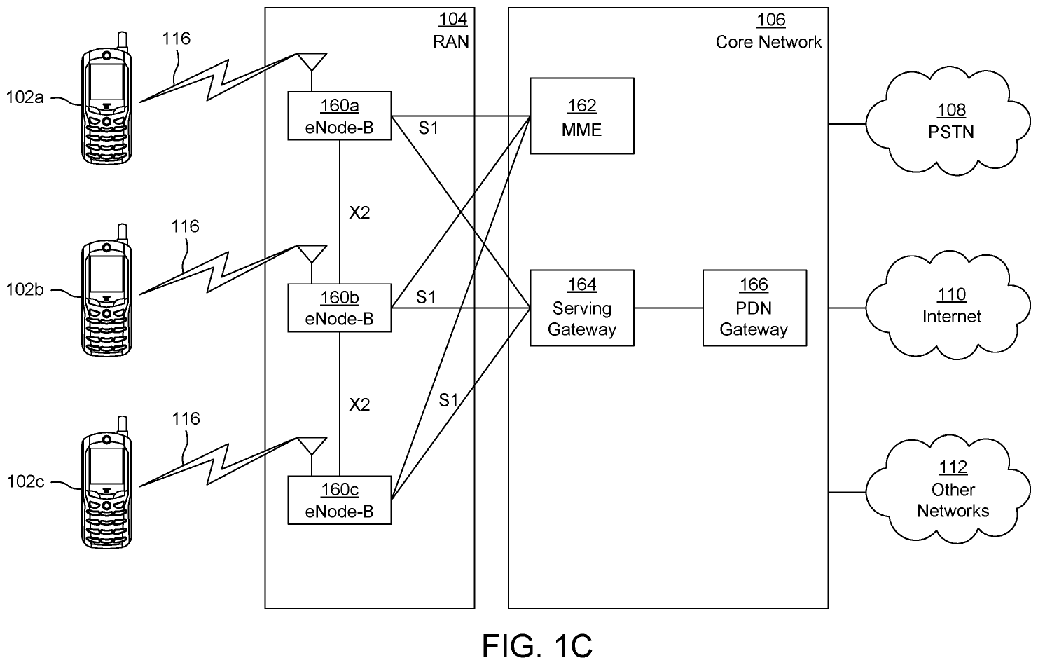

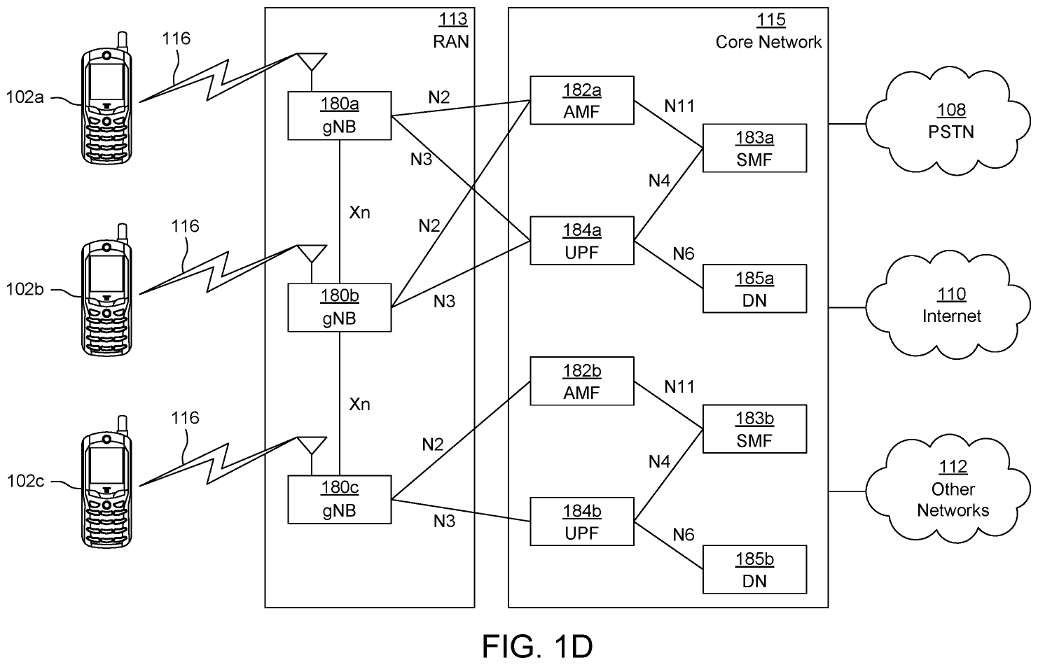

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “serving base station”, “base station”, “gNB”, “network” collectively “gNB” may be used interchangeably to designate any network element such as e.g., a network element acting as a serving base station. Embodiments described herein are not limited to gNBs and are applicable to any other type of serving base stations.

For the sake of clarity, satisfying, failing to satisfy a condition and “configuring condition parameter(s) are described throughout embodiments described herein as relative to a threshold (e.g., greater, or lower than) a (e.g., threshold) value, configuring the (e.g., threshold) value, etc.). For example, satisfying a condition may be described as being above a (e.g., threshold) value, and failing to satisfy a condition (e.g., performance criteria) may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”.

Throughout embodiments described herein, the terms “Uu”, “Uu interface” and “uplink/downlink” may be used interchangeably to refer to information (e.g., message(s)) to be exchanged between a WTRU and a base station (e.g., in a frequency channel) via any of uplink and downlink. Throughout embodiments described herein the terms “sidelink”, “PC5 interface”, “PC5” may be used interchangeably to refer to information (e.g., message(s)) to be exchanged between two WTRUs (e.g., in a frequency channel) via sidelink (SL).

### Examples of Services and Associated Network Characteristics

NR vehicle to everything (V2X) may be applicable to a broader set of more advanced V2X use cases and may be arranged into four use case groups: vehicular platooning, extended sensors, advanced driving, and remote driving.

Vehicle platooning may enable the vehicles to dynamically form a platoon travelling together. For example, (e.g., all) the vehicles in the platoon may obtain information from the leading vehicle to manage this platoon. This information may allow the vehicles to drive closer in a coordinated manner, going in the same direction and travelling together.

Extended sensors may enable the exchange of any of raw and processed data gathered through any of local sensors and live video images among any of vehicles, roadside units, devices of pedestrian and V2X application servers. The vehicles may increase the perception of their environment beyond what their own sensors can detect and may have a more broad and holistic view of the local situation. Extended sensors may rely on high data rate.

Advanced driving may enable semi-automated or full-automated driving. For example, a (e.g., each) vehicle and/or road side unit (RSU) may share its own perception (e.g., processed) data obtained from its local sensors with vehicles in proximity which may allow vehicles to synchronize and coordinate their trajectories or maneuvers. For example, a (e.g., each) vehicle may share its driving intention with vehicles in proximity.

Remote driving may enable any of a remote driver and a V2X application to operate a remote vehicle for those passengers who may not be able to drive by themselves, or remote vehicles that may be located in dangerous environments. In a case where variation is limited and routes are predictable, such as e.g., public transportation, driving based on cloud computing may be used. Remote driving may rely on high reliability and low latency.

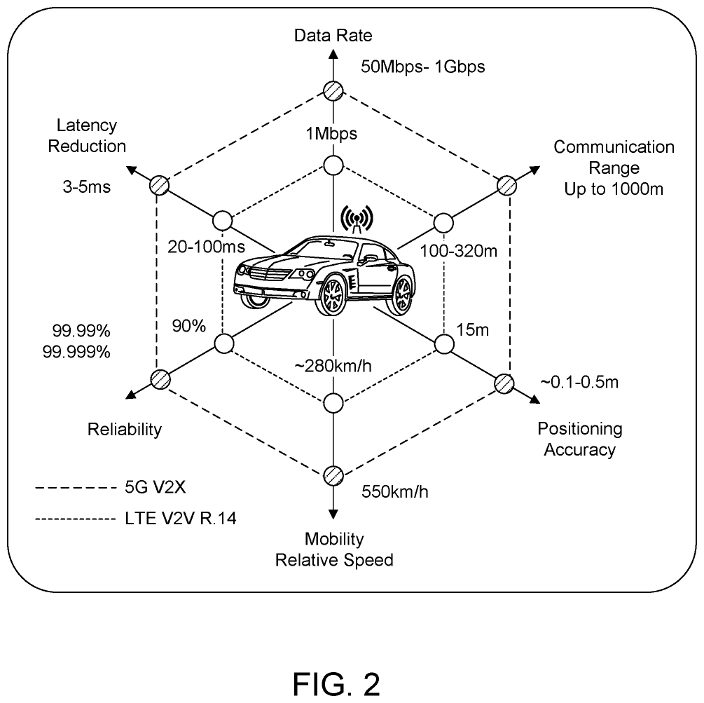

FIG. 2 is a diagram illustrating an example of 5G network characteristics versus LTE network characteristics. For example, 5G network characteristics may include an SL range up to 1000 m, a throughput up to 1 Gbps, a latency down to 3 milliseconds, a reliability up to 99.999%, and a transmission rate up to 100 messages/second. Other challenging network characteristics may include mobility relative speed and positioning accuracy. There is no use case which may expect all these bounding network characteristics to be met. There may be network characteristics relating to any of security, integrity, authorization, and privacy.

### NR V2X

NR V2X physical layer may support any of broadcast, unicast, and groupcast SL operation. The addition of unicast and groupcast may be linked with the introduction of SL hybrid automatic repeat request (HARQ) feedback, high order modulation, sidelink channel state information (SL CSI), and PC5-radio resource control (RRC), etc.

### Examples of Physical SL Channels and Signals

NR V2X SL may use any of (i) a physical sidelink broadcast channel (PSBCH) and its demodulation reference signals (DMRS), (ii) a physical sidelink control channel (PSCCH) and its DMRS, (iii) a physical sidelink shared channel (PSSCH) and its DMRS, (iv) a physical sidelink feedback channel (PSFCH), (v) a phase-tracking reference signal (PT-RS) in frequency range 2 (FR2), (vi) a channel state information reference signal (CSI-RS), and (vii) sidelink primary and secondary synchronization signals (S-PSS and S-SSS) which may be organized into the sidelink synchronization signal block (S-SSB) together with PSBCH. S-PSS and S-SSS may be referred to jointly as the sidelink synchronization signal (SLSS).

NR-V2X SL may support subcarrier spacings of any of 15, 30, 60 and 120 kHz. Their associations to cycle prefixes (CPs) and frequency ranges may be as for NR uplink/downlink, based on (e.g., only) the CP-OFDM waveform. The modulation available schemes may include any of quaternary phase shift keying (QPSK), 16-quadrature amplitude modulation (QAM), 64-QAM, and 256-QAM.

PSBCH may transmit the sidelink broadcast channel (SL-BCH) transport channel, which may carry (e.g., include) the SL V2X master information block (MIB-V2X) e.g., from the RRC layer. For example, PSBCH may transmit MIB-V2X every 160 milliseconds in 11 resource blocks (RBs) of the SL bandwidth, with e.g., repetitions in the period. DMRS associated with PSBCH may be transmitted in a (e.g., every) symbol of the S-SSB slot. Sidelink primary synchronization signal (S-PSS) and sidelink secondary synchronization signal (S-SSS) may be transmitted together with PSBCH in the S-SSB. They may jointly convey (e.g., indicate) the SLSS ID used by the WTRU.

Sidelink control information (SCI) in NR V2X may be transmitted in two stages. The first-stage SCI may be carried on PSCCH and may include information enabling sensing operations, and information indicating the resource allocation of the PSSCH.

PSSCH may transmit the second-stage SCI and the SL shared channel (SL-SCH) transport channel. The second-stage SCI may carry information that may be used to any of identify (e.g., and decode) the associated SL-SCH, control HARQ procedures, and trigger for channel state information (CSI) feedback, etc. SL-SCH may carry (e.g., include) the transport block (TB) of data for transmission over SL.

In a first example, the resources in which PSSCH may be transmitted may be scheduled or configured by a gNB. For example, a WTRU may receive (e.g., scheduling or configuration) information indicating the resource for PSSCH transmission. In a second example, the resources in which PSSCH may be transmitted may be determined through a sensing procedure conducted (e.g., autonomously) by the transmitting WTRU. A TB may be transmitted, for example, one or more times. DMRS associated with any of rank-1 and rank-2 PSSCH may be transmitted in any of two, three and four SL symbols distributed through a SL slot. Multiplexing between PSCCH and PSSCH may be in any of time and frequency within a slot.

PSFCH may carry (e.g., include) HARQ feedback over SL from a WTRU which may be an (e.g., intended) recipient of a PSSCH transmission (referred to herein as Rx WTRU) to the WTRU which may have performed the transmission (referred to herein as Tx WTRU). SL HARQ feedback may be in the form of any of (e.g., conventional) acknowledge (ACK)/non-acknowledge (NACK), and NACK (e.g., only) with nothing transmitted in case of successful decoding. A PSFCH transmission may include a Zadoff-Chu sequence in one physical resource block (PRB) repeated over two OFDM symbols, the first of which may be used for automatic gain control (AGC), near the end of the SL resource in a slot. The time resources for PSFCH may be (e.g., pre-) configured to occur once in every one, two, or four slots.

### Examples of Resource Allocation Modes

A first mode, which may be referred to herein as “mode 1” may be for resource allocation by the gNB. NR V2X applications may be associated with a diverse array of periodic and aperiodic message types. Resource allocation mode 1 may provide any of dynamic grants of SL resources from a gNB, and grants of periodic SL resources that may be semi-statically configured e.g., by RRC.

For example, a dynamic SL grant downlink control information (DCI) may provide (e.g., indicate) resources for one or more transmissions of a transport block, in order to allow control of reliability. The transmission(s) may be subject to the SL HARQ procedure in a case where HARQ operation is enabled.

For example, a SL configured grant may be such that it may be configured once (e.g., by receiving configuration information indicating the configured SL grant), and may be used by the WTRU (e.g., immediately) after receiving the configuration information, e.g., until it may be released by e.g., RRC signaling (which may be referred to herein as type 1). For example, a WTRU may (e.g., be allowed to) continue using this type of SL configured grant in a case where any of beam failure and physical layer problems occur in NR Uu until e.g., a radio link failure (RLF) detection timer expires (e.g., within a time period associated with a RLF detection event), before falling back to an (e.g., exception, fallback) resource pool. Another type of SL configured grant, which may be referred to herein as type 2), may be configured (e.g., once) and may not be used until the gNB may send to the WTRU a DCI indicating the grant may be active, and may be used until another DCI may be received, indicating de-activation. Any of type 1 and type 2 resources may be a set of SL resources recurring with a periodicity which may be matched (e.g., by the gNB) to the characteristics of the V2X traffic. One or more configured grants may be configured to allow provision for different services, traffic types, etc.

Modulation and coding scheme (MCS) information for any of dynamic and configured grants may be e.g., any of provided and constrained by RRC signaling. For example, RRC information may indicate any of an MCS and a range of MCS to be used by the Tx WTRU. In another example, the MCS may remain unconfigured. In a case where RRC information does not indicate a (e.g., single) MCS, the Tx WTRU may select an (e.g., appropriate) MCS e.g., based on (e.g., the knowledge of) the TB to be transmitted and, e.g., the SL radio conditions.

A second mode, which may be referred to herein as “mode 2” may be for WTRU autonomous resource selection. For example, a WTRU may be sensing, within a (e.g., pre-configured resource pool, which resources may not be used by other WTRU(s) with higher priority traffic and may select an (e.g., appropriate) amount of such resources for its own transmissions. Having selected such resources, the WTRU may any of transmit and re-transmit in the selected resources a (e.g., certain) number of times, or until a condition for resource reselection may be satisfied.

The mode 2 sensing procedure may be used to select (e.g., and reserve) resources for a variety of purposes illustrating that SL HARQ was introduced in NR V2X in support of unicast and groupcast in the physical layer. A WTRU may reserve resources to be used for a number of blind (re-)transmissions or HARQ-feedback-based (re-)transmissions of a transport block, in which case the resources may be indicated in the SCI(s) scheduling the transport block. In another example, the WTRU may select resources to be used for the initial transmission of a later transport block, in which case the resources may be indicated in an SCI scheduling a (e.g., current) transport block. For example, an initial transmission of a transport block may be performed after sensing and resource selection, e.g., without a reservation.

The first-stage SCIs transmitted by WTRUs on PSCCH may indicate the time-frequency resources in which the WTRU may transmit a PSSCH. These SCI transmissions may be used by sensing WTRUs to determine (e.g., maintain a record of) which resources may have been reserved by other WTRUs e.g., in the recent past.

In an example, the sensing WTRU may select resources for its (re-)transmission(s) from (e.g., within) a resource selection window (e.g., interval). The window (e.g., interval) may start (e.g., shortly) after the trigger for (re-)selection of resources and may not be longer than the remaining latency budget of the packet to be transmitted. Reserved resources in the selection window with SL reference signal receive power (RSRP) satisfying a condition (e.g., being above a threshold) may be excluded from being candidates by the sensing WTRU, with the condition (e.g., threshold) being set according to the priorities of the traffic of any of the sensing and transmitting WTRUs. For example, a higher priority transmission from a sensing WTRU may occupy (e.g., use) resources which may be reserved by a transmitting WTRU with any of lower sidelink reference signal receive power (SL-RSRP) and lower-priority traffic.

### Examples of Bandwidth Part

In a similar way as for uplink/downlink, bandwidth parts (BWPs) for SL may be considered in a WTRUs RF hardware chain implementation. A WTRU may be configured with one active SL BWP in a case where the WTRU is connected (e.g., in connected mode) to a gNB, which may be the same as the (e.g., single) SL BWP used for any of idle mode and out-of-coverage operation.

The subcarrier spacing used on SL may be provided in the SL BWP (e.g., pre-) configuration, from the same set of values and associations to frequency ranges as for the Uu interface (e.g., any of 15, 30, and 60 kHz for FR1, and any of 60 and 120 kHz for FR2). SL transmission and reception for a WTRU may be included within a SL BWP, and the same SL BWP may be used for any of transmitting and receiving. For example, any of resource pools and S-SSB, may be included within an (e.g., appropriate) SL BWP from the WTRU's perspective.

### Examples of NR and NR Unlicensed (NR-U)

5G NR system may allow to meet the connectivity expectations of a range of existing and future services to be deployable in an efficient manner. For example, NR may consider supporting use of frequency range up to 100 GHz.

NR specifications that have been developed in Rel-15 and Rel-16 define operation for frequencies up to 52.6 GHz, where all physical layer channels, signals, procedures, and protocols are designed for uses under 52.6GHz.

Frequencies above 52.6 GHz may be faced with more difficult challenges, such as higher phase noise, larger propagation loss due to high atmospheric absorption, lower power amplifier efficiency, and strong power spectral density regulatory requirements in unlicensed bands, compared to lower frequency bands. The frequency ranges above 52.6 GHz may contain larger spectrum allocations and larger bandwidths that may not be available for bands lower than 52.6 GHz.

As an initial effort to enable and improve 3GPP NR system for operation above 52.6 GHZ, 3GPP RAN has studied requirements for NR beyond 52.6 GHz up to 114.25 GHz including global spectrum availability and regulatory requirements (including channelization and licensing regimes), use cases and deployment scenarios, and NR system design considerations on top of regulatory requirements. Use cases identified in the study include high data rate eMBB, mobile data offloading, short range high-data rate device to device (D2D) communications, broadband distribution networks, integrated access backhaul (IAB), factory automation, industrial IoT (IIoT), wireless display transfer, augmented reality (AR)/virtual reality (VR) wearables, intelligent transport systems (ITS) and V2X, data center inter-rack connectivity, smart grid automation, private networks, and support of high positioning accuracy. The use cases span over several deployment scenarios identified in the study. The deployment scenarios include indoor hotspot, dense urban, urban micro, urban macro, rural, factor hall, and indoor D2D scenarios. The study also identified several system design properties around waveform, MIMO operation, device power consumption, channelization, bandwidth, range, availability, connectivity, spectrum regime considerations, and others.

Frequencies between 52.6 GHz and 71 GHz may be of interest e.g., in the short term due to their proximity to sub-52.6 GHz for which the current NR system may be designed and the commercial opportunities for high data rate communications, e.g., unlicensed spectrum and licensed spectrum between 57 GHz and 71 GHz.

NR Rel-15 defined two frequency ranges for operation: a first frequency range spanning from 410 MHz to 7.125 GHz, which may be referred to herein as FR1 and a second frequency range spanning from 24.25 GHz to 52.6 GHz, which may be referred to herein as FR2.

The proximity of the 57-71 GHz frequency range to FR2 and the commercial opportunities for high data rate communications may make it compelling for 3GPP to address NR operation in this frequency regime. FR2 operation was extended by 3GPP up to 71 GHz with the adoption of one or more new numerologies (e.g., larger subcarrier spacings), that may be identified on waveform for NR above 52.6 GHz. NR-U procedures for operation in unlicensed spectrum may be leveraged towards operation in the unlicensed 60 GHz band. NR operation may support up to 71 GHz considering licensed and unlicensed operation. Similar to NR and NR-U operations below 52.6 GHz, NR/NR-U operation in the 52.6 GHz to 71 GHz may be any of stand-alone and aggregated via carrier aggregation (CA) or dual connectivity (DC) with an anchor carrier.

In Release-16 new radio unlicensed (NR-U), the supported numerology (e.g., sub-carrier spacing (SCS)) may be set as any of 15, 30 and 60 KHz. The listen before talk (LBT) bandwidth may be set to 20 MHz in Release-16 NR-U. Based on the (e.g., minimum) LBT bandwidth that may be supported, the DL initial BWP may be 20 MHz for Rel-16 NR-U. Supported channel bandwidth may be up to 100 MHz. The WTRU channel bandwidth (or an activated BWP) may be set as an integer multiple of LBT bandwidth (e.g., 20 MHz). For instance, for SCS=30 KHz, the total allocated PRB numbers for 20 MHz, 40 MHz and 80 MHz bandwidth may be equal to 48, 102, and 214, respectively.

In an unlicensed band, a WTRU may sense the channel to determine whether the channel is available before performing a transmission. Such procedure is referred to as listen-before-talk (LBT). In Rel-16 NR-U, different LBT types, e.g., LBT type 1 channel access, type 2A channel access, type 2B channel access, etc., may allow to support different scenarios (e.g., sensing intervals).

In a case where the channel's energy level satisfies a condition (e.g., is below the defined threshold, e.g., LBT succeeded), the WTRU may transmit within the duration of a period of time which is referred to herein as the channel occupancy time (COT). After the COT may have expired, the WTRU may perform LBT again before any further transmission.

### Overview

NR Rel-18 will cover SL communication with FR1 unlicensed channel access (no beam management) and FR2 licensed operation with beam management. For mode 1, the SL operation on unlicensed spectrum may be considered with Uu operation using licensed spectrum while SL operation using unlicensed spectrum. Embodiments described herein may allow, for mode 1, to operate the SL on unlicensed spectrum with (e.g., both) Uu operation using unlicensed spectrum and SL operation using unlicensed spectrum.

In a case where (e.g., both) uplink/downlink and sidelink (e.g., transmissions) are operated in unlicensed band, the WTRU may perform channel access (e.g., sensing) for (e.g., both) uplink/downlink and sidelink for SL mode-1 operation to complete a SL transmission scheduled by the base station through uplink/downlink. For example, channel access (e.g., sensing) may be performed independently for Uu and SL. The gNB's SL scheduling on SL unlicensed frequency may be inaccurate and inefficient due to the channel uncertainty on Uu and SL and due to the inability of the scheduler at the base station to any of timely receive feedback (such as e.g., any of buffer status report (BSR), scheduling request (SR), SL HARQ feedback) related to communication on SL, and to timely transmit scheduling information to the Tx WTRU.

Embodiments described herein may allow to improve the latency and the system performance in unlicensed bands by improving the channel access efficiency. Several mechanisms for channel access with COT sharing are described herein.

In embodiments described herein, methods for channel access procedure for the operation of SL mode 1 on the unlicensed spectrum with (e.g., both) Uu unlicensed and SL unlicensed are described. The described methods include a channel access procedure with COT sharing initiated by the Tx WTRU, a channel access procedure with COT sharing initiated by the Tx WTRU with assistance information from the Rx WTRU, a channel access procedure with COT sharing initiated by the gNB, a channel access procedure with COT sharing initiated by the gNB with assistance information from the Tx WTRU, a channel access procedure with COT sharing initiated by the gNB with assistance information from the Rx WTRU and a channel access procedure with COT sharing initiated by the gNB with assistance information from the Tx WTRU and the Rx WTRU.

In embodiments described herein the terms “assistant information” and “assistance information” may be used interchangeably to refer to an additional piece of information to be transmitted and/or used with another piece of information.

Methods of channel access for operating of SL mode 1 on unlicensed spectrum with (e.g., both) Uu operation and SL operation using unlicensed spectrum are described herein.

### Example Channel Access Procedure with COT Sharing Initiated by the Tx WTRU for SL Unlicensed (SL-U) Mode 1

In SL mode 1, a WTRU may receive grant information from the gNB to perform a SL transmission.

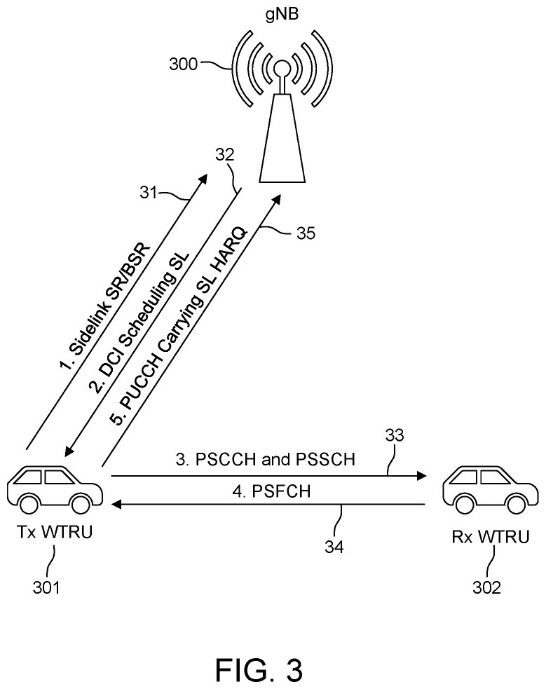

FIG. 3 is a diagram illustrating an example of SL mode 1 operation using dynamic scheduling.

In a first step, in a case where a Tx WTRU 301 has some data to be transmitted, the Tx WTRU 301 may send first scheduling information 31 associated with a SL transmission e.g., to be performed in SL unlicensed. The first scheduling information 31 may indicate any of a SL scheduling request (SL-SR) and a SL buffer status report (SL-BSR) to get (e.g., receive) grant information from the gNB 300.

In a second step, after the gNB 300 may have received the first scheduling information 31 indicating any of the SL-SR and the SL-BSR, the gNB 300 may transmit second scheduling information 32, by using DCI, e.g., DCI format 3_0, indicating any of the resource allocation for the SL transmission and other SL grant related information to the Tx WTRU 301.

In a third step, after receiving the second scheduling information 32 indicating the scheduled resource on SL, e.g., DCI format 3_0, the Tx WTRU 301 may perform the scheduled (e.g., PSCCH and PSSCH) transmission 33 to the Rx WTRU 302.

In a fourth step, the Rx WTRU 302 may monitor the transmission of PSCCH and the corresponding PSSCH. In a case where HARQ feedback is enabled for the PSSCH transmission, the Rx WTRU 302 may send the HARQ feedback 34 to the Tx WTRU 301 using the enabled HARQ scheme through the PSFCH.

In a fifth step, after receiving the HARQ feedback 34 from the Rx WTRU 302, the Tx WTRU 301 may forward the HARQ feedback result 35 of the SL transmission to the gNB 300 using the physical uplink control channel (PUCCH). For example, the gNB 300 may (e.g., make the decision and) schedule the subsequent resource for SL transmission based on the received HARQ feedback result 35 from the Tx WTRU 301.

In a case where sidelink unlicensed (SL-U) mode 1 is operating with (e.g., both) Uu and sidelink in unlicensed spectrum, the WTRU may access (e.g., sense) the channel on (e.g., both) the Uu interface and the PC5 interface to perform the transmission. For example, channel access (e.g., sensing) may be performed on the Uu interface to transmit any of (i) SL scheduling request information, (ii) SL buffer status report information, (iii) a scheduling DCI, (iv) PUCCH information, etc. Channel access (e.g., sensing) may be performed on the PC5 interface to transmit any of PSCCH information, the PSSCH information, PSFCH information, etc.

The transmission network element, e.g., gNB, WTRU, Tx WTRU, Rx WTRU, etc. may be expected by regulation to perform channel access before performing a transmission on the unlicensed spectrum (also referred to as shared spectrum). Channel access may comprise performing sensing on the channel for a (e.g., certain) period. Such behavior may be referred to herein as LBT. In a case where the channel is sensed to be idle for at least a (e.g., certain) sensing interval, which may be referred to as LBT success, the transmission node may perform the transmission on the unlicensed spectrum. In a case where the channel is sensed to be busy (e.g., not idle), which may be referred to as LBT failure, the transmission node may not perform the transmission on the unlicensed spectrum. Throughout embodiments described herein, LBT is used to describe the procedure performed by a transmission network element to access the channel. Embodiments described herein are not limited to the use of LBT to perform channel access, and any other technique to access a channel in a shared spectrum may be applicable to embodiments described herein. Throughout embodiments described herein the terms “LBT”, “channel sensing”, and other notations of channel access schemes may be used interchangeably.

According to embodiments, sharing a channel occupancy time (COT) may allow to address the channel uncertainty. For example, a COT may be initiated and may be shared by the transmission on the Uu interface and the transmission on the SL. Throughout embodiments described herein a shared COT may be referred to a COT that may be shared between any of uplink, downlink and SL transmissions e.g., in unlicensed spectrum. For example, in a case where a COT is initiated by a network element, the other network elements that the COT may be shared with may initiate a transmission in the COT without LBT, e.g., channel access type 2C, or may initiate a transmission in the COT using a short LBT, e.g., channel access type 2A with a sensing interval of 25 us or channel access type 2B with a sensing interval of 16 μs, etc.

SL WTRUs and the base station may adapt the timings of their transmission so as not to exceed any of a (e.g., configured) time and regulatory thresholds. In a case where a transmission is going to exceed any of a (e.g., configured) time and regulatory thresholds the transmission network element may initiate a new independent channel access by performing a full LBT e.g., using more time and increasing the risk of loss of scheduled resource.

In an example, (e.g., limited) COT sharing information may be combined with SR for transmission in PUCCH. This information may indicate to the gNB whether the gNB may share the COT initiated by the Tx WTRU or not. For example, the (e.g., limited) COT sharing information may indicate that a COT may have been initiated by the Tx WTRU, and that the COT may be shared by the Tx WTRU and the gNB. In an example, the (e.g., limited) COT sharing information may not include explicit information indicating when the shared COT may start. For example, the shared COT may start with the transmission including (e.g., limited) COT sharing information. In another example, the (e.g., limited) COT sharing information may include (e.g., explicit) information indicating when the shared COT may start. For example, the (e.g., limited) COT sharing information may indicate the duration of the COT. For example, the COT sharing information may be conditioned upon the channel access priority class used by the SL Tx WTRU to initiate the COT.

COT sharing information may indicate additional details on the COT sharing, which may be included, for example, in a MAC control element (MAC CE). In an embodiment, BSR information may include additional information elements indicating the COT such as e.g., any of a priority class, a starting time, a remaining time etc. In an embodiment, a (e.g., new) MAC CE may include information indicating COT parameters and sharing indication (e.g., information). For example, the MAC CE may be transmitted to the gNB by the SL Tx WTRU initiating the COT.

In an embodiment, the COT may be initiated by the Tx WTRU (e.g., of the SL transmission).

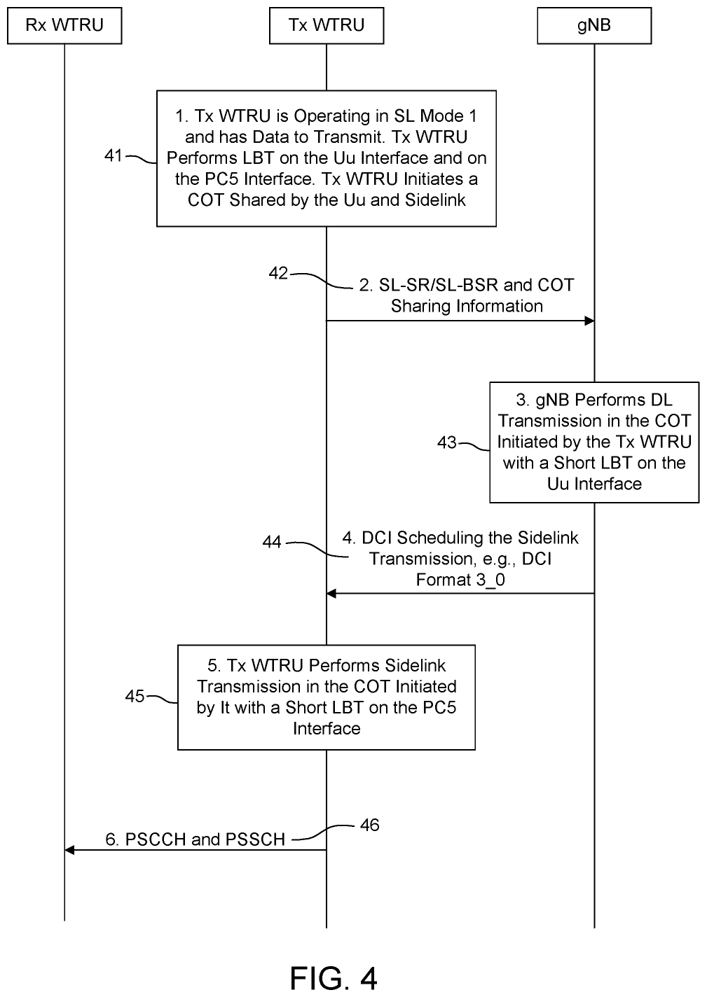

FIG. 4 is a diagram illustrating an example channel access procedure with COT sharing initiated by a Tx WTRU for SL-U with unlicensed Uu and unlicensed SL.

As shown at 41, the Tx WTRU may perform LBT on the Uu and sidelink to collect channel availability information (e.g., to determine whether the channel is available). Based on the LBT result, the Tx WTRU may initiate a COT that may be shared by (e.g., both) Uu and SL, e.g., in a case where the channel is determined to be available on any of Uu and SL. In an example, the WTRU may initiate the COT to be shared by Uu and SL in a case where the channel is determined to be available on Uu (e.g., only), e.g., based on successful LBT on Uu (e.g., only). In another example, the WTRU may initiate the COT to be shared by Uu and SL in a case where the channel is determined to be available on (e.g., both) Uu and SL (e.g., based on successful LBT on (e.g., both) Uu and SL). For example, the Tx WTRU may perform one LBT on (e.g., both) Uu and SL e.g., in parallel to access (e.g., sense) the channel. In another example, the Tx WTRU may perform separate (e.g., sequential) LBT on Uu and SL respectively (e.g., one after the other) to access (e.g., sense) the channel.

For example, the Tx WTRU may send first scheduling information 42 in the initiated COT indicating any of (i) a SL-SR, (ii) a SL-BSR and (iii) COT sharing information (e.g., indicating that the COT may be shared) to the gNB.

As shown at 43, the gNB may receive the transmission from the Tx WTRU and may determine that a COT may have been initiated by the Tx WTRU and that the COT may be shared by the Tx WTRU and the gNB for transmissions on (e.g., both) Uu and SL. For example, the gNB may schedule an SL transmission in response to the first scheduling information 42 indicating any of a SL-SR and a SL-BSR from the Tx WTRU within the initiated COT.

In another example, in a case where the WTRU is configured with configured grants, the gNB may reply to the SR/BSR request by transmitting a short indication that may (re)activate the configured grant. The short indication may be prepared in a short time and transmitted within the same COT duration to avoid the gNB to perform LBT.

For example, the gNB may transmit the DCI 44 carrying (e.g., including) the SL scheduling information to the Tx WTRU e.g., after the LBT may succeed. For example, the gNB may (e.g., directly) send the DCI 44 scheduling the SL transmission (e.g., including the SL scheduling information) on the Uu interface within the COT initiated by the Tx WTRU without performing LBT. In another example, the gNB may perform a short LBT, e.g., a type 2 channel access procedure, before transmitting the (e.g., scheduling) DCI 44 to the Tx WTRU.

In a case where a dynamic grant DCI is used with COT sharing, the time gap value in the DCI may refer to a new higher layer parameter (which may be referred to as sl-DCI-ToSL-Trans-Unlicensed) that may list (e.g., indicate) a different series of slot gap values, so that shorter times may be indicated compared to the regular sl-DCI-ToSL-Trans parameter.

As shown at 45, after receiving the DCI 44, the Tx WTRU may check whether the scheduled SL transmission may be within the initiated COT. In a case where the scheduled SL transmission is determined to be within the initiated COT, the Tx WTRU may (e.g., directly) perform the SL transmission on the PC5 interface e.g., without performing the LBT. In another example, the Tx WTRU may perform a short LBT, e.g., a type 2 channel access procedure, before transmitting the scheduled (e.g., PSCCH and PSSCH) transmission to the Rx WTRU.

For example, the Tx WTRU may transmit the scheduled (e.g., PSCCH and PSSCH) transmission 46 to the Rx WTRU, e.g., within the COT.

In an embodiment, the Rx WTRU may send assistance information to the Tx WTRU to help (e.g., assist) the Tx WTRU to initiate the COT.

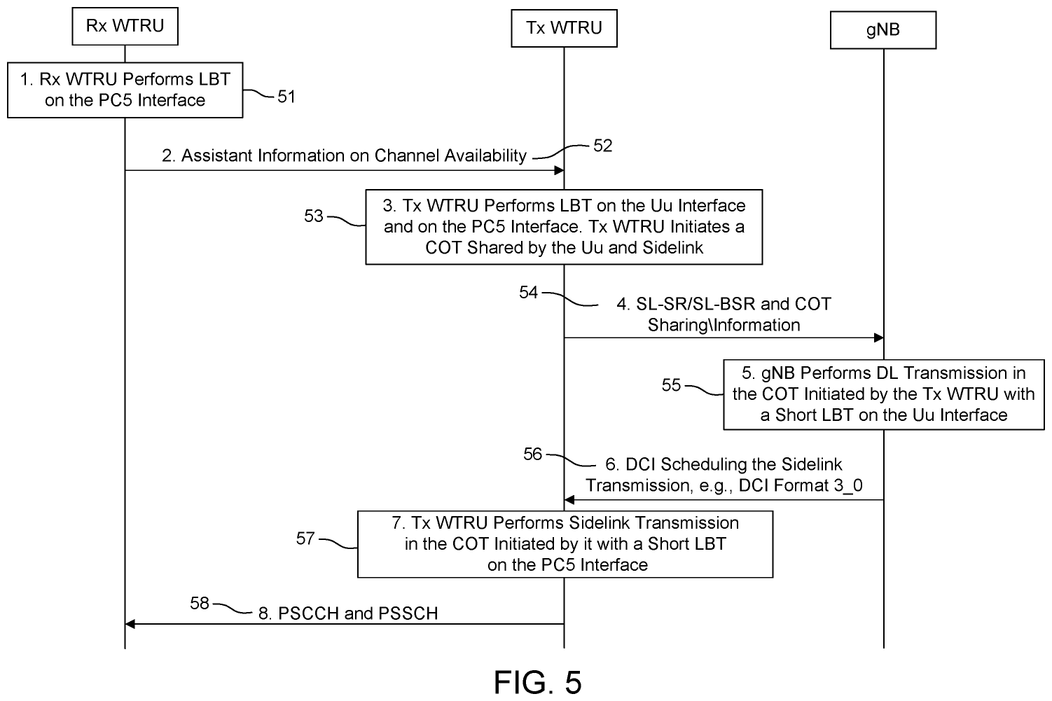

FIG. 5 is a diagram illustrating an example channel access procedure with COT sharing initiated by a Tx WTRU with assistance information from the Rx WTRU for SL-U with unlicensed Uu and unlicensed SL.

As shown at 51, the Rx WTRU may perform LBT on the PC5 interface to collect the channel availability information (e.g., to determine whether the channel may be available for a SL transmission). For example, the Rx WTRU may determine whether assistance information 52 may be sent to the Tx WTRU.

For example, the Rx WTRU may send assistance information 52 to the Tx WTRU in a case where the LBT on SL succeeded. The assistance information 52 may indicate any of (i) a channel available starting time, (ii) available candidate resources, (iii) a channel busy time, (iv) a channel available duration, (v) a channel busy ratio, and (vi) an available sub-band indicator, to help the gNB to perform SL scheduling. Throughout embodiments described herein, assistance information may be transmitted by a Tx network element (NE) (e.g., of assistance information) that may be any of a Rx WTRU of a SL transmission and a Tx WTRU of a SL transmission. Similarly, throughout embodiments described herein, assistance information may be received by a Rx NE that may be any of a Tx WTRU of a SL transmission and a gNB.

A channel available starting time may indicate the starting time when the channel may be available. For example, the Tx NE may predict when the channel may be available and may send information indicating the predicted time to the Rx NE. For example, the Tx NE may include time offset information in the assistance information to indicate the time offset between the starting time of the available channel and the time of sending the assistance information. In another example, the Tx NE may include information indicating any of a frame index, a subframe index, a slot index, and a symbol index in the assistance information to indicate the starting time location of the available channel. In another example, the Tx NE may include a bit map in the assistance information to indicate which time resources may be available. For example, a (e.g., each) bit map may be associated with any of one frame, one subframe, one slot, and one symbol. In another example, the Tx NE may send information indicating the time that the channel was available. For example, the Tx NE may send information indicating at which time the channel was available in a past time window. For example, the duration of the window may be configured by the gNB e.g., through RRC signaling. The Tx NE may send information indicating that the channel was available in which time resources during this window to the Rx NE, e.g., through a bitmap, etc., as assistance information.

Available candidate resources may be indicated by the Tx NE as a set of candidate resources (e.g., sub-channels with slot indications) which may be estimated to be available to the base station. For example, SL devices (e.g., WTRUs) may be listening over (e.g., monitoring) the SL to receive incoming transmissions which may be transmitted by other SL devices (e.g., WTRUs) operating in any of mode 1 and mode 2. For example, the listening SL devices (e.g., WTRUs) may derive (e.g., determine, estimate) which channel resources may be going to be busy or available over the SL. This information may be combined with the unlicensed SL channel availability to obtain (e.g., a list of) available candidate resources that may be expected to be available for transmission (e.g., by the Tx WTRU). For instance, channel monitoring for SL data reception may give the indication of the reserved transmission time and frequency resources, such that the WTRU may obtain (e.g., a list of) available or non-available time in a future time period.

Channel busy time may be indicated by the Tx NE as the time that the channel may have been busy. For example, the Tx NE may indicate in the channel busy time at which time the channel may have been busy in a past time window. The duration of the window may be configured by the gNB e.g., through RRC signaling. The Tx NE may indicate to the Rx NE in which time resources during this window the channel may have been busy e.g., through a bitmap, etc., as assistance information.

Channel available duration may be indicated by the Tx NE as the duration over which the channel may be available (e.g., in the future). For example, the Tx NE may indicate any of a symbol duration, a slot duration, a subframe duration and a frame duration to the Rx NE.

A channel busy ratio may be indicated by the Tx WTRU as channel busy ratio in a past time window to the Rx NE, where the duration of the window may be configured by the gNB e.g., through RRC signaling. The channel busy ratio may be indicated as e.g., the percentage of the channel busy rate. For example, a value of X may be indicated if the channel busy rate is X % in the past time window. In another example, the channel busy ratio may be indicated as a quantized value, such as e.g., any of ¼, 2/4, ¾, 4/4 etc. In yet another example the channel busy ratio may be indicated as channel busy level, such as e.g., any of high, medium, low, etc. (e.g., which may be indicated by a value associated with the level).

An available sub-band indicator may be indicated by the Tx NE as to which frequency band may be available to the Rx NE. For example, the frequency band, e.g., SL BWP, that the WTRU may be operating with for SL mode 1 may be divided into one or more SL sub-bands. For example, a (e.g., each) SL sub-band may be associated with a number of bandwidths, e.g., 20 MHz. In another example, a (e.g., each) SL sub-band may be associated with a number of subchannels, e.g., k subchannels where k may be an integer that may be configured by the gNB e.g., through RRC signaling. The Tx NE may indicate the available SL sub-bands to the Rx NE. For example, a bit map may be used to indicate which SL sub-bands may be available among (e.g., all of) them.

In an embodiment, the transmission of (e.g., channel availability) assistance information may be triggered by (e.g., based on) a SL transmission that may be to be performed, the Rx WTRU being the destination WTRU or one of the destination WTRUs of the SL transmission. For example, in a case where the Tx WTRU has data to be transmitted on SL to the Rx WTRU, the Tx WTRU may send information indicating a trigger to the destination (e.g., Rx) WTRU to trigger the Rx WTRU to transmit (e.g., channel availability) information to the Tx WTRU. After receiving information indicating the trigger from the Tx WTRU, the Rx WTRU may perform LBT on SL and may transmit (e.g., channel availability) assistance information to the Tx WTRU.

In an embodiment, the Rx WTRU may periodically perform the LBT on SL and may (e.g., periodically) transmit (e.g., channel availability) assistance information to the Tx WTRU e.g., independently of whether there is a SL transmission intended for the Rx WTRU. In this embodiment, no information indicating a trigger for sending (e.g., channel availability) assistance information may be sent by the Tx WTRU (e.g., to the Rx WTRU).

As shown at 53, the Tx WTRU may use the assistance information received from the Rx WTRU to initiate a COT that may be shared by (e.g., both) Uu and SL. For example, the Rx WTRU may initiate a COT to be shared by (e.g., both) Uu and SL based on the assistance information 52 received from the Rx WTRU. For example, the Tx WTRU may perform sensing (e.g., only) on the Uu and may initiate the COT based on the assistance information 52 received from the Rx WTRU (and e.g., based on the Uu channel sensing result). In another example, the Tx WTRU may perform sensing on (e.g., both) the Uu and the SL, and may initiate the COT based on the assistance information 52 received from the Rx WTRU (and e.g., based on Uu and SL channel sensing results). For example, the Tx WTRU may perform one LBT on (e.g., both) Uu and SL e.g., in parallel to access (e.g., sense) the channel. In another example, the Tx WTRU may perform separate (e.g., sequential) LBT on Uu and SL respectively (e.g., one after the other) to access (e.g., sense) the channel.

Steps labelled 55 and 57 in FIG. 5 may be similar to steps labelled 43 and 45 in FIG. 4 respectively. Transmissions labelled 54, 56 and 58 in FIG. 5 may be similar to transmissions labelled 42, 44 and 46 in FIG. 4 respectively.

### Example of Channel Access Procedure with COT Sharing Initiated by the gNB for SL-U Mode 1

In an embodiment, the COT may be initiated by the gNB. Based on the regulation, a network element may not initiate a COT with an infinite length. Any of a gNB and a WTRU may initiate a COT of a duration that may be up to 10 milliseconds. For example, after receiving scheduling information indicating any of a SL-SR and a SL-BSR, the gNB may not (e.g., immediately) schedule the SL transmission. In a case where the SL transmission is scheduled later, e.g., at least 50 milliseconds after reception of the scheduling information, the SL transmission may fall outside a COT that may have been initiated by the Tx WTRU. A gNB initiated COT may allow a gNB to delay the scheduling of a SL transmission after reception of the scheduling information (e.g., indicating any of a SL-SR and a SL-BSR) and to keep the SL transmission in the COT. For example, the gNB may initiate the COT at the time the SL transmission may be scheduled (e.g., transmitted). In another example, the gNB may initiate the COT at the time scheduling information (e.g., DCI) may be transmitted by the gNB to indicate when the SL transmission may be scheduled. By (e.g., proper) scheduling the SL transmission, e.g., keep the gap (e.g., interval) between the scheduled SL transmission and the transmission of the DCI carrying the scheduling information below the (e.g., max) duration of the COT, the COT may be shared among more than one transmitting network elements (e.g., gNB and WTRUs).

For example, information indicating COT sharing may be transmitted from the gNB to the WTRU, for example, included in the DCI. For example, the information may indicate that the COT may have been started by the gNB and that the COT may be shared with SL WTRUs.

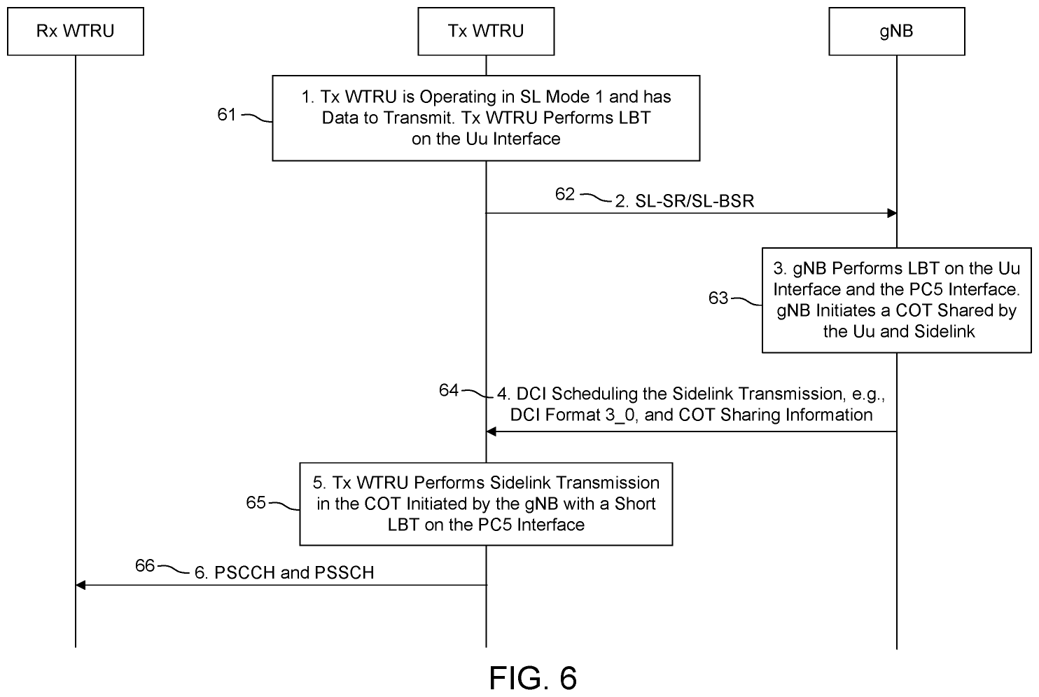

FIG. 6 is a diagram illustrating an example channel access procedure with COT sharing initiated by the gNB for SL-U with (e.g., both) Uu unlicensed and SL unlicensed.

In step 61, in a case where the Tx WTRU has data to transmit on the SL, the Tx WTRU may perform LBT on the Uu. For example, in a case of successful LBT, the Tx WTRU may send first scheduling information 62 indicating any of a SL-SR and a SL-BSR to the gNB.

In step 63, the gNB may perform LBT on any of Uu and sidelink to collect channel availability information (e.g., to determine whether the channel is available on any of the Uu and SL interfaces). Based on the LBT result, the gNB may initiate a COT that may be shared by (e.g., both) Uu and SL, e.g., in a case where any of the channel on Uu and the channel on SL is determined to be available. In an example, the gNB may initiate the COT to be shared by Uu and SL in a case where the channel is determined to be available on Uu (e.g., only), e.g., based on successful LBT on Uu (e.g., only). In another example, the gNB may initiate the COT to be shared by Uu and SL in a case where the channel is determined to be available on (e.g., both) Uu and SL (e.g., based on successful LBT on (e.g., both) Uu and SL).

For example, the gNB may transmit second scheduling information 64 (e.g., in a DCI) to the Tx WTRU, indicating any of the SL scheduling information and COT sharing information (e.g., indicating a shared COT). For example, the COT sharing information may indicate any of a priority class, a starting time of the shared COT, and a remaining time of the shared COT.

In step 65, the Tx WTRU may receive the second scheduling information 64 from the gNB. The Tx WTRU may determine that a COT may have been initiated by the gNB and that the scheduling of the SL transmission may be located within the initiated COT (e.g., the Tx WTRU may determine that the SL transmission may be scheduled in the initiated COT based on the second scheduling information 64). The Tx WTRU may determine that the COT initiated by the gNB may be shared by the Tx WTRU and the gNB for transmissions on (e.g., both) Uu and SL. For example, the Tx WTRU may (e.g., directly) send the scheduled SL transmission to the Rx WTRU without performing LBT, e.g., based on the determination that the SL transmission may have been scheduled in the shared COT. In another example, the Tx WTRU may perform a short LBT, such as e.g., a type 2 channel access procedure, before transmitting the scheduled SL transmission to the Rx WTRU, e.g., based on the determination that the SL transmission may have been scheduled in the shared COT. For example, the Tx WTRU may transmit the scheduled (e.g., PSCCH and PSSCH) transmission 66 to the Rx WTRU, e.g., based on the determination that the SL transmission may have been scheduled in the shared COT.

In an embodiment, The Tx WTRU may transmit assistance information to the gNB to assist the gNB in initiating the COT. For example, the following procedures (not illustrated) may be added to steps described in FIG. 6.

In step 61, the Tx WTRU may (e.g., also) perform LBT on SL to collect the channel availability information (e.g., to determine whether the channel is available on SL). For example, the Tx WTRU may send assistance information to the gNB. For example, the assistance information may be included (e.g., indicated by) the first scheduling information 62. The assistance information may indicate any of a channel available time, a channel busy time, a channel available duration, a channel busy ratio, a channel occupancy ratio, and an available sub-band indicator, etc., according to embodiments described herein. In step 63, the gNB may initiate the COT based (e.g., also) on the channel availability (e.g., assistance) information reported by the Tx WTRU.

In an embodiment, the Rx WTRU may transmit (e.g., further) assistance information.

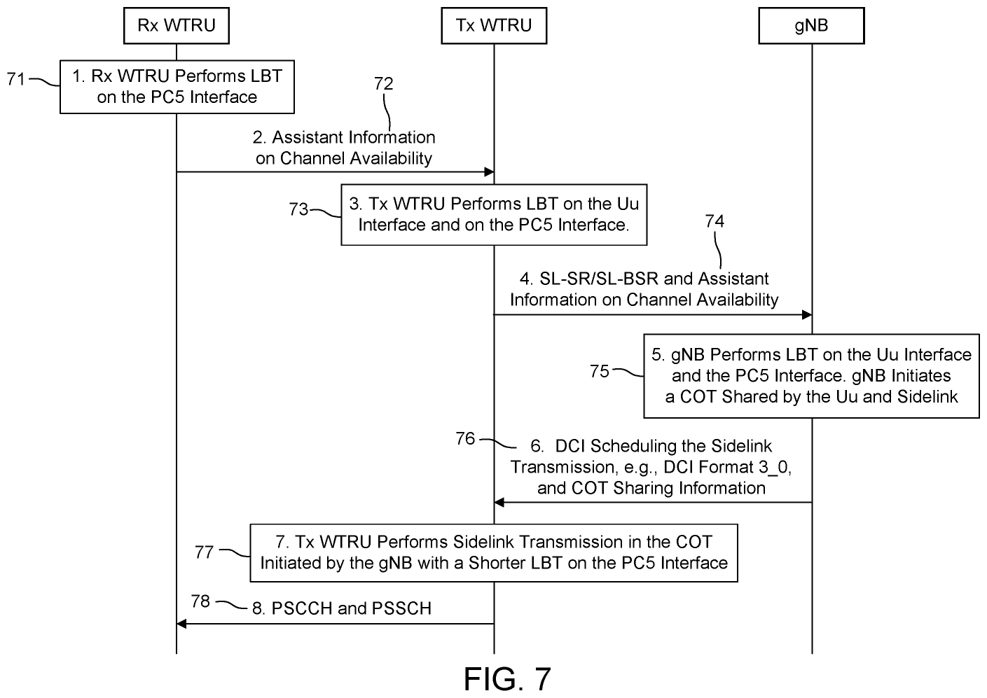

FIG. 7 is a diagram illustrating an example channel access procedure with COT sharing initiated by the gNB with assistance information from the Rx WTRU for SL-U with Uu unlicensed and SL unlicensed.

In step 71, the Rx WTRU may perform LBT on the PC5 interface, for example, to collect the channel availability information. For example, the Rx WTRU may determine at which time first (e.g., channel availability) assistance information 72 may be transmitted to the Tx WTRU. For example, the Rx WTRU may send first (e.g., channel availability) assistance information 72 to the Tx WTRU based on a successful LBT on SL. For example, first (e.g., channel availability) assistance information 72 may indicate any of the following information such as e.g., a channel available time, a channel busy time, a channel available duration, a channel busy ratio, an available sub-band indicator, etc., according to any embodiments described herein. For example, the Rx WTRU may be triggered (e.g., requested) by the Tx WTRU (e.g., by receiving information indicating) to perform sensing on the SL and to report first (e.g., channel availability) assistance information 72 to the Tx WTRU. In another example the Rx WTRU may periodically report first (e.g., channel availability) assistance information 72 to the Tx WTRU.

In step 73, after receiving first (e.g., channel availability) assistance information 72 from the Rx WTRU, the Tx WTRU may (e.g., directly) use it as assistance information and may send second (e.g., channel availability) assistance information to the gNB. For example, the Tx WTRU may not perform LBT on the SL to add additional assistance information. The Tx WTRU may perform LBT (e.g., only) on the Uu and may send second (e.g., channel availability) assistance information to the gNB based on the first (e.g., channel availability) assistance information 72 received from the Rx WTRU. In another example, the Tx WTRU may perform LBT on (e.g., both) Uu and SL. The Tx WTRU may (e.g., also) perform LBT on the SL and may update the first (e.g., channel availability) assistance information based on the SL LBT result. The Tx WTRU may send the updated first (e.g., channel availability) assistance information to the gNB based on a successful LBT on the Uu interface. For example, the Tx WTRU may send information 74 indicating any of a SL-SR, a SL-BSR, and second assistance information to the gNB based on a successful LBT on the Uu interface.

In step 75, the gNB may perform LBT on Uu and SL to collect channel availability information, respectively on Uu and SL. Based on any of the LBT result and the channel availability information reported by the Tx WTRU, the gNB may initiate a COT that may be shared by (e.g., both) Uu and SL.

The step labelled 77 in FIG. 7 may be similar to the step labelled 65 in FIG. 6. Transmissions labelled 76 and 78 in FIG. 7 may be similar to transmissions labelled 64 and 66 in FIG. 6 respectively.

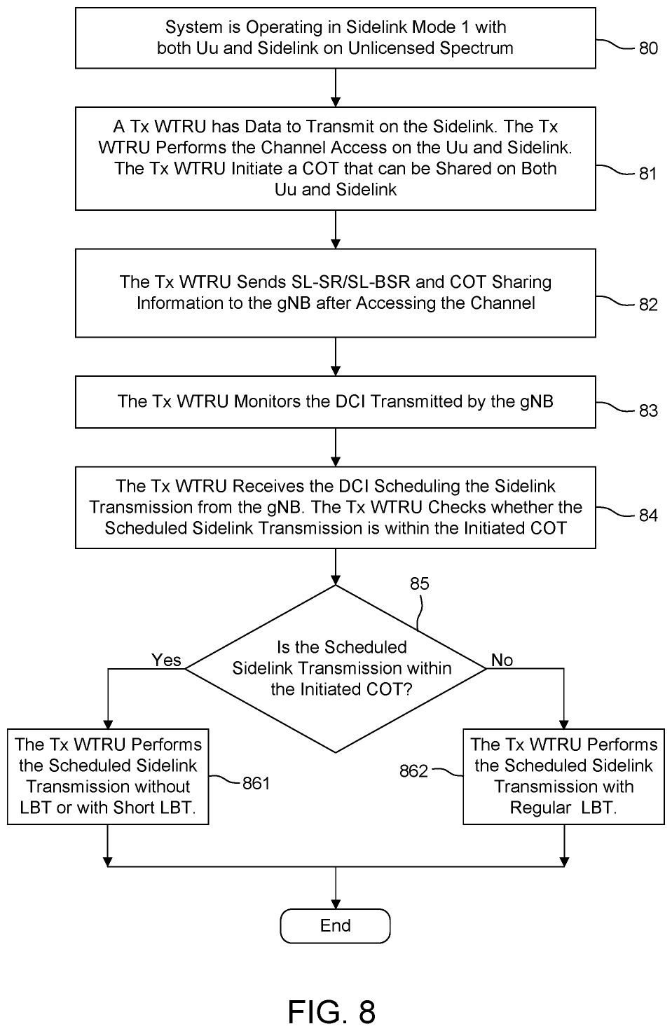

FIG. 8 is a diagram illustrating an example of SL-U mode 1 channel access with WTRU initiated COT sharing for Uu and SL. For example, as shown at 80, a WTRU may be operating in SL mode 1 with (e.g., both) Uu in unlicensed spectrum and SL in unlicensed spectrum.

In an example, as shown at 81, a Tx WTRU may have data to transmit on SL. The Tx WTRU may perform channel access (e.g., sensing) on Uu and SL. For example, the Tx WTRU may initiate a COT that may be shared on (e.g., both) Uu and sidelink, and may share the COT with the gNB. As shown at 82, the Tx WTRU may send scheduling information indicating any of SL-SR, SL-BSR and COT sharing information to the gNB. As shown at 83, the Tx WTRU may monitor the DCI As shown at 84, the Tx WTRU may receive the DCI indicating scheduling one or more SL transmissions. As shown at 85, the Tx WTRU may determine whether the DCI indicates that one or more SL transmissions are scheduled within the COT. In a case where at least one SL transmission is scheduled within the COT, as shown at 861, the Tx WTRU may perform the at least one SL transmission with any of no LBT and a short LBT, otherwise, as shown at 862, the Tx WTRU may perform the one or more SL transmissions with regular LBT.

In another example, a Tx WTRU may have data to transmit on SL. The Tx WTRU may perform channel access (e.g., sensing) on Uu and SL. For example, the Tx WTRU may initiate a COT that may be shared on (e.g., both) Uu and SL, and may share the COT with the gNB. The Tx WTRU may initiate the COT, for example, with (e.g., based on) assistance information received from the Rx WTRU. The Tx WTRU may send information indicating any of an SL-SR, an SL-BSR and COT sharing information to the gNB. The Tx WTRU may monitor and may detect the DCI indicating scheduling one or more SL transmissions e.g., within the COT. In a case where the DCI indicates that at least one SL transmission may be scheduled within the COT, the Tx WTRU may perform the SL transmission with any of no LBT and short LBT.

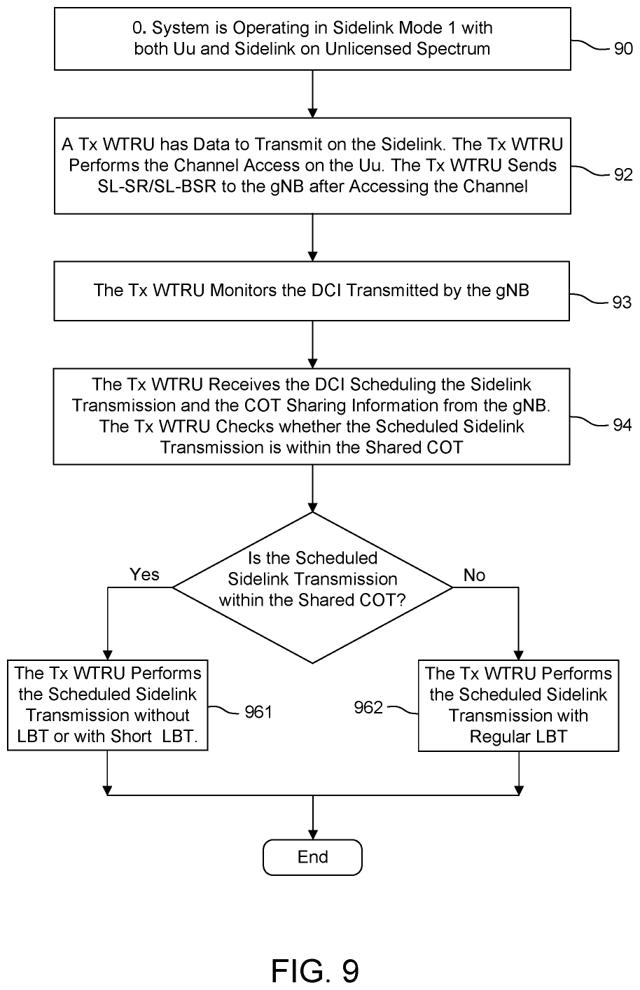

FIG. 9 is a diagram illustrating an example of SL-U mode 1 channel access with gNB initiated COT sharing for Uu and SL. For example, as shown at 90, a WTRU may be operating in SL mode 1 with (e.g., both) Uu and SL in unlicensed spectrum.

In an example, as shown at 92, a Tx WTRU may have data to transmit on SL. For example, the Tx WTRU may perform channel access (e.g., sensing) on the Uu. The Tx WTRU may send first scheduling information indicating any of a SL-SR and a SL-BSR to the gNB. As shown at 93, the Tx WTRU may monitor second scheduling information (e.g., DCI) e.g., transmitted by the gNB. As shown at 94, the Tx WTRU may detect (e.g., receive) the second scheduling information (e.g., DCI) indicating any of scheduling the SL transmission and COT sharing information. The Tx WTRU may check whether the SL transmission is scheduled within the COT shared by the gNB. In a case where the second scheduling information (e.g., DCI) indicates that the SL transmission is scheduled within the COT, as shown at 961, the Tx WTRU may perform the SL transmission with any of no LBT and a short LBT. In a case where the second scheduling information (e.g., DCI) indicates that the SL transmission is scheduled after the COT, as shown at 962, the Tx WTRU may perform the SL transmission with regular (e.g., full) LBT.

In another example, a Tx WTRU may have data to transmit on SL. For example, the Tx WTRU may perform channel access (e.g., sensing) on Uu and sidelink. The Tx WTRU may send, to the gNB, first scheduling information indicating any of a SL-SR, a SL-BSR and assistant information, which may be used to assist the gNB in initiating the COT. For example, the Tx WTRU may monitor and detect (e.g., receive) second scheduling information (e.g., DCI) indicating any of scheduling the SL transmission and the COT sharing information e.g., transmitted by the gNB. For example, the Tx WTRU may check whether the second scheduling information (e.g., DCI) indicates a SL transmission scheduled within the COT shared by the gNB. In a case where the second scheduling information (e.g., DCI) indicates a SL transmission scheduled within the COT, the Tx WTRU may perform the SL transmission with any of no LBT and short LBT.

In yet another example, a Tx WTRU may have data to transmit on SL. For example, the Tx WTRU may perform channel access (e.g., sensing) on Uu. For example, the Tx WTRU may collect (e.g., receive) assistance information from the Rx WTRU. For example, the Tx WTRU may send, to the gNB, first scheduling information indicating any of a SL-SR, a SL-BSR and assistant information, which may be used to assist the gNB in initiating the COT. The assistance information sent to the gNB may be, for example, a consolidation (e.g., an aggregation, based on) the assistance information received from the Rx WTRU and the Tx WTRU sensing result. In another example the assistance information sent to the gNB may be (e.g., purely) the assistance information received from the Rx WTRU, forwarded by the Tx WTRU to the gNB. For example, the Tx WTRU may monitor and detect second scheduling information (e.g., DCI) indicating any of scheduling the SL transmission and the COT sharing information transmitted by the gNB. The Tx WTRU may check whether the second scheduling information (e.g., DCI) indicates an SL transmission scheduled within the COT shared by the gNB. In a case where the second scheduling information (e.g., DCI) indicates an SL transmission scheduled within the COT shared by the gNB, the Tx WTRU may perform the SL transmission with any of no LBT and short LBT.

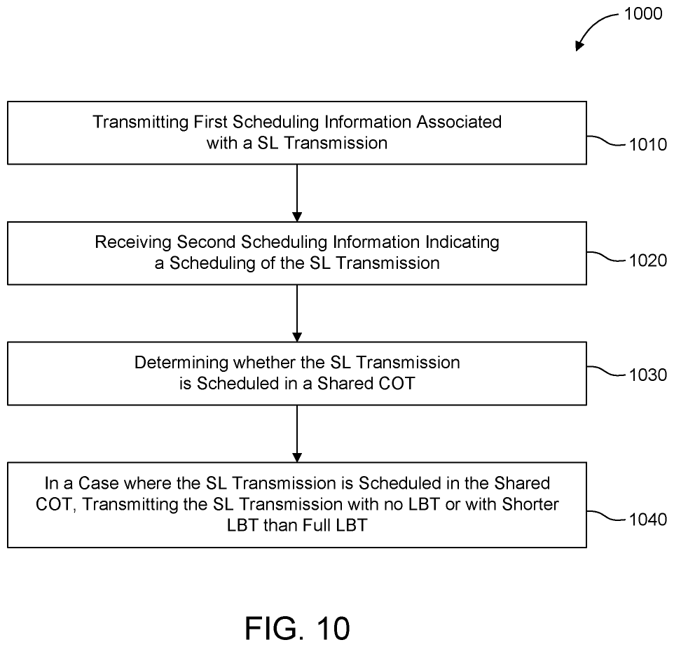

FIG. 10 is a diagram illustrating an example method 1000 for sharing a COT between a WTRU and a base station. The method 1000 may be implemented in a WTRU. As shown at 1010, the WTRU may transmit to a base station, first scheduling information associated with an SL transmission to be transmitted to another WTRU in unlicensed spectrum. As shown at 1020, the WTRU may receive, from the base station, second scheduling information indicating a scheduling of the SL transmission. As shown at 1030, the WTRU may determine whether the SL transmission may be scheduled in a channel occupancy time shared with any of uplink, downlink and SL in the unlicensed spectrum. As shown at 1040, in a case where the SL transmission is scheduled in the shared channel occupancy time, the WTRU may transmit, to the other WTRU, the SL transmission with no listen before talk (LBT) or with a shorter LBT than a full LBT.

In various embodiments, the first scheduling information may indicate that the shared channel occupancy time may have been started by the WTRU.

In various embodiments, the first scheduling information associated with the SL transmission may indicate any of an SL scheduling request, an SL buffer status report and channel occupancy time sharing information.

In various embodiments, the channel occupancy time sharing information may indicate any of a priority class a starting time of the shared channel occupancy time and a remaining time of the shared channel occupancy time.

In various embodiments, the WTRU may further perform channel sensing on an unlicensed Uu (e.g., uplink) channel and an unlicensed SL channel, wherein the first scheduling information may be transmitted (e.g., to the base station) in a case where the unlicensed Uu (e.g., uplink) channel and the unlicensed SL channel are determined to be available.

In various embodiments, the WTRU may further receive from the other WTRU prior to transmitting the first scheduling information, assistance information indicating SL channel availability.

In various embodiments, the shared channel occupancy time may be started based on the assistance information.

In various embodiments, the assistance information may indicate any of (i) a channel available starting time, (ii) available candidate resources, (iii) a channel busy time, (iv) a channel available duration, (v) a channel busy ratio, and (vi) an available sub-band indicator.

In various embodiments, the second scheduling information may indicate that the shared channel occupancy time may have been started by the base station.

In various embodiments, the second scheduling information may indicate any of a priority class a starting time of the shared channel occupancy time and a remaining time of the shared channel occupancy time.

In various embodiments, the WTRU may further perform first SL channel sensing on an unlicensed SL channel to be used for the SL transmission, wherein the first SL channel sensing may be performed before transmitting the first scheduling information (e.g., to the base station).

In various embodiments, the first scheduling information may indicate first SL channel availability results obtained by the first SL channel sensing.

In various embodiments, the WTRU may further receive assistance information indicating second SL channel availability results of a second SL channel sensing performed by the other WTRU.

In various embodiments, the first scheduling information may further indicate the second SL channel availability results of the second SL channel sensing.

In various embodiments, the first scheduling information may indicate any of (i) a channel available starting time, (ii) available candidate resources, (iii) a channel busy time, (iv) a channel available duration, (v) a channel busy ratio, and (vi) an available sub-band indicator.

In various embodiments, in a case where the SL transmission is scheduled after the shared channel occupancy time, the WTRU may further transmit, to the other WTRU, the SL transmission with full LBT.

In various embodiments, the shorter LBT may comprise sensing over a sensing interval of 16 or 25 microseconds.

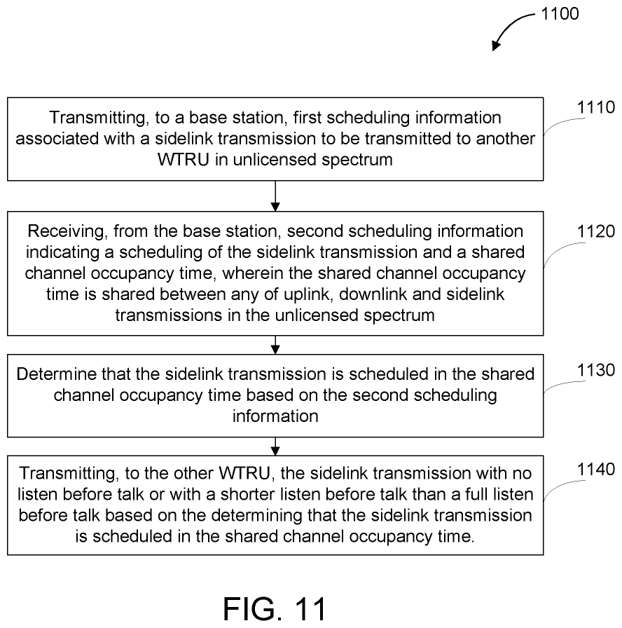

FIG. 11 is a diagram illustrating an example method 1100 for sharing a COT between a WTRU and a base station, the shared COT being initiated by the base station. The method 1100 may be implemented in a WTRU. As shown at 1110, the WTRU may transmit, to a base station, first scheduling information associated with a sidelink transmission to be transmitted to another WTRU in unlicensed spectrum. As shown at 1120, the WTRU may receive, from the base station, second scheduling information indicating a scheduling of the sidelink transmission and a shared channel occupancy time, wherein the shared channel occupancy time may be shared between any of uplink, downlink and sidelink transmissions in the unlicensed spectrum. As shown at 1130, the WTRU may determine that the sidelink transmission may be scheduled in the shared channel occupancy time based on the second scheduling information. As shown at 1140, the WTRU may transmit, to the other WTRU, the sidelink transmission with no listen before talk or with a shorter listen before talk than a full listen before talk based on the determining that the sidelink transmission may be scheduled in the shared channel occupancy time.

In various embodiments, the first scheduling information associated with the sidelink transmission may indicate any of a sidelink scheduling request and a sidelink buffer status report.

In various embodiments, the second scheduling information may indicate that the shared channel occupancy time may have been started by the base station.

In various embodiments, the second scheduling information indicating the shared channel occupancy time may indicate any of a priority class, a starting time of the shared channel occupancy time and a remaining time of the shared channel occupancy time.

In various embodiments, the WTRU may perform first sidelink channel sensing on an unlicensed channel to be used for the sidelink transmission, wherein the first sidelink channel sensing may be performed before transmitting the first scheduling information to the base station.

In various embodiments, the first scheduling information may indicate first sidelink channel availability results obtained based on the first sidelink channel sensing.

In various embodiments, the WTRU may receive from the other WTRU prior to transmitting the first scheduling information, information indicating second sidelink channel availability results of a second sidelink channel sensing.

In various embodiments, the first scheduling information may comprise assistance information based on any of the first sidelink channel availability results and the second sidelink channel availability results.

In various embodiments, the assistance information may indicate any of (i) a channel available starting time, (ii) available candidate resources, (iii) a channel busy time, (iv) a channel available duration, (v) a channel busy ratio, and (vi) an available sub-band indicator.

In various embodiments, in a case where the sidelink transmission is scheduled after the shared channel occupancy time, the WTRU may transmit, to the other WTRU, the sidelink transmission with full listen before talk.

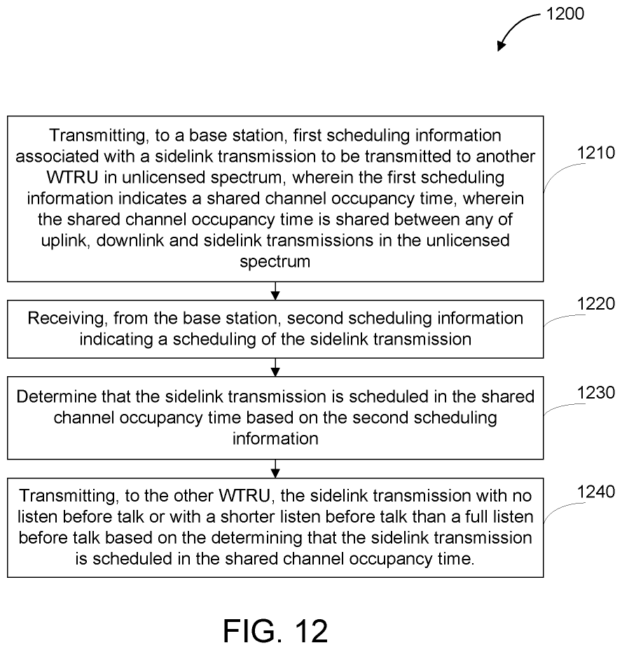

FIG. 12 is a diagram illustrating an example method 1200 for sharing a COT between a WTRU and a base station, the shared COT being initiated by the WTRU. The method 1200 may be implemented in a WTRU. As shown at 1210, the WTRU may transmit, to a base station, first scheduling information associated with a sidelink transmission to be transmitted to another WTRU in unlicensed spectrum. The first scheduling information may indicate, for example, a shared channel occupancy time, that may be shared between any of uplink, downlink and sidelink transmissions in the unlicensed spectrum. As shown at 1220, the WTRU may receive, from the base station, second scheduling information indicating a scheduling of the sidelink transmission. As shown at 1230, the WTRU may determine that the sidelink transmission may be scheduled in the shared channel occupancy time based on the second scheduling information. As shown at 1240, the WTRU may transmit, to the other WTRU, the sidelink transmission with no listen before talk or with a shorter listen before talk than a full listen before talk based on the determining that the sidelink transmission may be scheduled in the shared channel occupancy time.

In various embodiments, the first scheduling information associated with the sidelink transmission may indicate any of a sidelink scheduling request and a sidelink buffer status report.

In various embodiments, the first scheduling information may indicate that the shared channel occupancy time may have been started by the WTRU.

In various embodiments, the first scheduling information indicating the shared channel occupancy time may indicate any of a priority class, a starting time of the shared channel occupancy time and a remaining time of the shared channel occupancy time.

In various embodiments, the WTRU may perform first sidelink channel sensing on an unlicensed channel to be used for the sidelink transmission, wherein the first sidelink channel sensing may be performed before transmitting the first scheduling information to the base station.

In various embodiments, the first scheduling information may indicate first sidelink channel availability results obtained based on the first sidelink channel sensing.

In various embodiments, the WTRU may receive from the other WTRU prior to transmitting the first scheduling information, information indicating second sidelink channel availability results of a second sidelink channel sensing.

In various embodiments, the first scheduling information may comprise assistance information based on any of the first sidelink channel availability results and the second sidelink channel availability results.

In various embodiments, the assistance information may indicate any of (i) a channel available starting time, (ii) available candidate resources, (iii) a channel busy time, (iv) a channel available duration, (v) a channel busy ratio, and (vi) an available sub-band indicator.

In various embodiments, in a case where the sidelink transmission is scheduled after the shared channel occupancy time, the WTRU may transmit, to the other WTRU, the sidelink transmission with full listen before talk.

Any characteristic, variant or embodiment described for a method is compatible with an apparatus device comprising means for processing the disclosed method, with a device comprising circuitry, including any of a transmitter, a receiver, a processor, and a memory, the circuitry being configured to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶6 or means-plus-function claim format, and any claim without the terms “means for” is not so intended.

1. A wireless transmit/receive unit (WTRU) comprising circuitry, including any of a transmitter, a receiver, a processor, and a memory, wherein the circuitry is configured to:
receive, from a peer WTRU, assistance information on channel availability at the peer WTRU, wherein the assistance information indicates one or more available resources, and wherein the one or more available resources are available for transmission;
perform a first sidelink channel sensing to update the one or more available resources;
transmit, to a base station, first scheduling information associated with a sidelink transmission to be transmitted to the peer WTRU in unlicensed spectrum, wherein the first scheduling information indicates the updated one or more available resources;
receive, from the base station, second scheduling information indicating a scheduling of the sidelink transmission and a shared channel occupancy time, wherein the shared channel occupancy time is shared among any of uplink, downlink and sidelink transmissions in the unlicensed spectrum;
determine that the sidelink transmission is scheduled in the shared channel occupancy time based on the second scheduling information; and
transmit, to the peer WTRU, based on the sidelink transmission being scheduled in the shared channel occupancy time, the sidelink transmission with no listen before talk or with a shorter listen before talk time period than a full listen before talk time period.

2. The WTRU of claim 1, wherein the first scheduling information associated with the sidelink transmission indicates any of a sidelink scheduling request and a sidelink buffer status report.

3. The WTRU of claim 1, and wherein the second scheduling information indicates that the shared channel occupancy time has been started by the base station.

4. The WTRU of claim 1, to wherein the second scheduling information indicating the shared channel occupancy time further indicates any of a priority class, a starting time of the shared channel occupancy time and a remaining time of the shared channel occupancy time.

5. (canceled)

6. The WTRU of claim 1, wherein the first scheduling information indicates first sidelink channel availability results obtained based on the first sidelink channel sensing.

7. The WTRU of claim 1, wherein the assistance information indicates second sidelink channel availability results of a second sidelink channel sensing at the peer WTRU.

8. The WTRU of claim 7, wherein the first scheduling information indicates the second sidelink channel availability results.

9. The WTRU of claim 8, wherein the first scheduling information indicates any of (i) a channel available starting time, (ii) available candidate resources, (iii) a channel busy time, (iv) a channel available duration, (v) a channel busy ratio, and (vi) an available sub-band indicator.

10. The WTRU of claim 1, configured to transmit the sidelink transmission with full listen before talk to the peer WTRU in a case where the sidelink transmission is scheduled after the shared channel occupancy time.

11. A method implemented in a wireless transmit/receive unit (WTRU), the method comprising:
receiving, from a peer WTRU, assistance information on channel availability at the peer WTRU, wherein the assistance information indicates one or more available resources, and wherein the one or more available resources are available for transmission;
performing a first sidelink channel sensing to update the one or more available resources;
transmitting, to a base station, first scheduling information associated with a sidelink transmission to be transmitted to the peer WTRU in unlicensed spectrum, wherein the first scheduling information indicates the updated one or more available resources;
receiving, from the base station, second scheduling information indicating a scheduling of the sidelink transmission and a shared channel occupancy time, wherein the shared channel occupancy time is shared among any of uplink, downlink and sidelink transmissions in the unlicensed spectrum;
determining that the sidelink transmission is scheduled in the shared channel occupancy time based on the second scheduling information; and
transmitting, to the peer WTRU, based on the sidelink transmission being scheduled in the shared channel occupancy time, the sidelink transmission with no listen before talk or with a shorter listen before talk time period than a full listen before talk time period.

12. The method of claim 11, wherein the first scheduling information associated with the sidelink transmission indicates any of a sidelink scheduling request and a sidelink buffer status report.

13. The method of claim 11, and wherein the second scheduling information indicates that the shared channel occupancy time has been started by the base station.

14. The method of claim 11, to wherein the second scheduling information indicating the shared channel occupancy time further indicates any of a priority class, a starting time of the shared channel occupancy time and a remaining time of the shared channel occupancy time.

15. (canceled)

16. The method of claim 11, wherein the first scheduling information indicates first sidelink channel availability results obtained based on the first sidelink channel sensing.

17. The method of claim 11, wherein the assistance information indicates second sidelink channel availability results of a second sidelink channel sensing at the peer WTRU.

18. The method of claim 17, wherein the first scheduling information indicates the second sidelink channel availability results.

19. The method of claim 11, wherein the first scheduling information indicates any of (i) a channel available starting time, (ii) available candidate resources, (iii) a channel busy time, (iv) a channel available duration, (v) a channel busy ratio, and (vi) an available sub-band indicator.

20. The method of claim 11, comprising, in a case where the sidelink transmission is scheduled after the shared channel occupancy time, transmitting, to the peer WTRU, the sidelink transmission with full listen before talk.

21. The WTRU of claim 1, wherein the one or more available resources comprise one or more available sub-bands in the unlicensed spectrum.

22. The method of claim 11, wherein the one or more available resources comprise one or more available sub-bands in the unlicensed spectrum.
